(19) United States
(12) Patent Application Publication
(10) Pub. No.: US 2010/0238491 A1
(43) Pub. Date: Sep. 23, 2010

(54) PRINT MANAGEMENT APPARATUS, PRINT MANAGEMENT METHOD AND RECORDING MEDIUM

(75) Inventors: Yoshiko Shiimori, Ashigarakami-gun (JP); Eiji Uesugi, Yokohama-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/710,667

(22) Filed: Feb. 23, 2010

(30) Foreign Application Priority Data
Mar. 17, 2009 (JP) JP2009-064507

(51) Int. Cl. G06F 15/00

(52) U.S. Cl. 358/1.15

(57) ABSTRACT

A print management apparatus includes: a device for storing position information of a plurality of printing terminals placed in different locations, information indicating a condition of a file printable by each printing terminal, and print data; a device for receiving position information of a mobile terminal owned by a user; a device for identifying an appropriate printing terminal from among the plurality of printing terminals based on the received position information of the mobile terminal and the position information of the plurality of printing terminals; a device for modifying a file format of the print data so that the print data satisfies the condition; a device for sending the modified print data to the appropriate printing terminal; and a device for extracting position information of the appropriate printing terminal based on the position information of the printing terminals and for notifying the mobile terminal of the extracted position information.

### BACKGROUND OF THE INVENTION

1. Field of the Invention

The presently disclosed subject matter relates to a print management apparatus, a print management method, and a recording medium, and particularly to a print management apparatus, a print management method, and a recording medium which use a mobile terminal.

2. Description of the Related Art

Japanese Patent Application Laid-Open No. 2008-102653 and Japanese Patent Application Laid-Open No. 2006-53614 disclose a system which identifies a store or a printer which perform a printing based on position information of a mobile terminal and notifies the mobile terminal of position information of the store or printer.

### SUMMARY OF THE INVENTION

However, Japanese Patent Application Laid-Open No. 2008-102653 and Japanese Patent Application Laid-Open No. 2006-53614 do not disclose how to handle cases where data for print does not meet a condition for print at the store or the printer (for example, a case where a file format of the data for print is unsupported by the store or the printer).

The presently disclosed subject matter is made in view of such circumstances, and an object of the presently disclosed subject matter is to provide a print management apparatus, a print management method, and a recording medium which can guide a user to printing at a printing terminal appropriate for the user even if data for print does not satisfy a condition for print of the printing terminal.

A first aspect of the presently disclosed subject matter can provide a print management apparatus including: a storing device for storing position information of a plurality of printing terminals placed in different locations, information indicating a condition of a file printable by each printing terminal, and print data; a receiving device for receiving position information of a mobile terminal owned by a user; a terminal identifying device for identifying an appropriate printing terminal from among the plurality of printing terminals based on the received position information of the mobile terminal and the position information of the plurality of printing terminals stored in the storing device; a data modifying device for modifying a file format of the print data so that the print data satisfies the condition of the file stored in the storing device; a sending device for sending the print data modified by the data modifying device to the appropriate printing terminal; and a notifying device for extracting position information of the appropriate printing terminal based on the position information of the printing terminals stored in the storing device and for notifying the mobile terminal of the extracted position information.

In the first aspect, position information of a plurality of printing terminals is stored in the storing device. And, when position information of the mobile terminal owned by a user is received, an appropriate printing terminal is identified from among the plurality of printing terminals based on the received position information of the mobile terminal and the position information stored in the storing device. Information indicating a condition of a file printable by a printing terminal is also stored in the storing device. The file format of the print data is modified so that the print data satisfies the condition of the file, and the modified print data is sent to the appropriate printing terminal. Meanwhile, the position information of the appropriate printing terminal is extracted from the position information stored in the storing device, and the extracted position information is provided to the mobile terminal. Thereby, the user can be guided to printing at the printing terminal appropriate for the user even in a case where printable file formats do not satisfy a file format condition of the printing terminal, a case where the file format of print data is different from a file format supportable by a printing terminal, and the like.

A second aspect of the presently disclosed subject matter can provide the print management apparatus according to the first aspect, wherein the storing device stores at least one of a file size, a paper size, and a file format as the information indicating the condition of the file printable by the printing terminal.

According to the print management apparatus of the second aspect, at least one of a file size, a paper size, and a file format is stored as information indicating a condition of a file printable by the printing terminal, and at least one of a file size, a paper size, and a file format of print data is modified, so that the print data can be printed by an appropriate printing terminal.

A third aspect of the presently disclosed subject matter can provide a print management apparatus including: a storing device for storing position information of a plurality of printing terminals placed in different locations, and print data; a receiving device for receiving position information of a mobile terminal owned by a user; a terminal identifying device for identifying an appropriate printing terminal from among the plurality of printing terminals based on the received position information of the mobile terminal and the position information of the plurality of printing terminals stored in the storing device; a sending device for sending the print data stored in the storing device to the appropriate printing terminal; a determining device for determining whether or not the mobile terminal is within a predetermined range from the appropriate printing terminal based on the position information of the mobile terminal and the position information of the printing terminals; a controlling device for performing control so as to allow printing at the appropriate printing terminal only if the determining device determines that the mobile terminal is within the predetermined range from the appropriate printing terminal; and a notifying device for extracting position information of the appropriate printing terminal based on the position information of the printing terminals stored in the storing device and notifying the mobile terminal of the extracted position information.

In the third aspect, the position information of a plurality of printing terminals is stored in the storing device. When position information of a mobile terminal owned by a user is received, an appropriate printing terminal is identified from among the plurality of printing terminals based on the received position information of the mobile terminal and the position information stored in the storing device. Whether or not the mobile terminal has entered within a predetermined range from the appropriate printing terminal is determined based on the position information of the mobile terminal and position information of the appropriate printing terminal, and printing at the appropriate printing terminal is allowed only if it is determined that the mobile terminal has entered within the predetermined range from the appropriate printing terminal. This can reduce risk that printed material may be seen by other people, print data may be printed by other people, and the like. Therefore, a secure printing method can be provided.

A fourth aspect of the presently disclosed subject matter can provide the print management apparatus according to the third aspect, wherein the controlling device controls the sending device to send the print data to the appropriate printing terminal if the determining device determines that the mobile terminal is within a predetermined distance from the appropriate printing terminal.

According to the print management apparatus of the fourth aspect, print data is sent to an appropriate printing terminal if it is determined that a mobile terminal has entered within a predetermined distance from the appropriate printing terminal. This can reduce risk that print data may be printed by other people.

A fifth aspect of the presently disclosed subject matter can provide the print management apparatus according to any one of the first to fourth aspects, wherein the receiving device receives information indicating a movement path of the user who owns the mobile terminal, and the terminal identifying device identifies the movement path of the user based on the received information about the movement path, and identifies a printing terminal existing within a predetermined range away from the identified movement path of the user, as the appropriate printing terminal.

According to the print management apparatus of the fifth aspect, information about the movement path of a user who owns a mobile terminal is received, the movement path of the user is identified based on the received information about the movement path, and a printing terminal existing within a predetermined range away from the identified movement path is identified as an appropriate printing terminal. Thereby, a printing terminal in a location near the movement path can be determined to be the appropriate printing terminal.

A sixth aspect of the presently disclosed subject matter can provide the print management apparatus according to the fifth aspect, wherein the receiving device acquires a destination of the user, and the terminal identifying device identifies the movement path of the user based on the received destination and the position information of the mobile terminals.

According to the print management apparatus of the sixth aspect, the movement path of a user can be identified based on the destination of the user and the position information of mobile terminals.

A seventh aspect of the presently disclosed subject matter can provide the print management apparatus according to any one of the first to fourth aspects, further including a current time acquiring device for acquiring a current time, wherein the storing device stores a schedule of the user, and the terminal identifying device identifies the movement path of the user based on the schedule of the user and the acquired current time, and identifies a printing terminal existing within a predetermined range away from the identified movement path of the user, as the appropriate printing terminal.

According to the print management apparatus of the seventh aspect, the movement path of a user can be identified based on a current time and a schedule of the user.

A eighth aspect of the presently disclosed subject matter can provide a print management method including the steps of: receiving position information of a mobile terminal owned by a user, by a print management apparatus; identifying an appropriate printing terminal from among a plurality of printing terminals based on the received position information of the mobile terminal and position information of the plurality of printing terminals stored in a storing device of the print management apparatus; modifying a file format of print data stored in the storing device so that the print data satisfies a condition of a file printable by the printing terminal stored in the storing device; sending the modified print data to the appropriate printing terminal; and extracting position information of the appropriate printing terminal from the position information of the printing terminals and notifying the mobile terminal of the extracted position information.

A ninth aspect of the presently disclosed subject matter can provide a print management method including the steps of: receiving position information of a mobile terminal owned by a user, by a print management apparatus; identifying an appropriate printing terminal from among a plurality of printing terminals based on the received position information of the mobile terminal and position information of the plurality of printing terminals stored in a storing device of the print management apparatus; sending print data stored in the storing device to the appropriate printing terminal; determining whether or not the mobile terminal is within a predetermined range from the appropriate printing terminal based on the position information of the mobile terminal and the position information of the printing terminals; performing control so as to allow printing at the appropriate printing terminal only if the determining step determines that the mobile terminal is within the predetermined range from the appropriate printing terminal; and extracting position information of the appropriate printing terminal from the position information of the printing terminals stored in the storing device and notifying the mobile terminal of the extracted position information.

A tenth aspect of the presently disclosed subject matter can provide a computer-readable recording medium including instructions stored thereon, such that when the instructions are read and executed by a processor, the processor is configured to perform the steps of: receiving position information of a mobile terminal owned by a user; identifying an appropriate printing terminal from among a plurality of printing terminals based on the received position information of the mobile terminal and stored position information of the plurality of printing terminals stored in a storing device; modifying a file format of print data stored in the storing device so that the print data satisfies a condition of a file printable by the printing terminal stored in the storing device; sending the modified print data to the appropriate printing terminal; and extracting position information of the appropriate printing terminal from the position information of the printing terminals and notifying the mobile terminal of the extracted position information.

A eleventh aspect of the presently disclosed subject matter can provide a computer-readable recording medium including instructions stored thereon, such that when the instructions are read and executed by a processor, the processor is configured to perform the steps of: receiving position information of a mobile terminal owned by a user; identifying an appropriate printing terminal from among a plurality of printing terminals based on the received position information of the mobile terminal and position information of the plurality of printing terminals stored in a storing device; sending print data stored in the storing device to the appropriate printing terminal; determining whether or not the mobile terminal is within a predetermined range from the appropriate printing terminal based on the position information of the mobile terminal and the position information of the printing terminals; performing control so as to allow printing at the appropriate printing terminal only if the determining step determines that the mobile terminal is within the predetermined range from the appropriate printing terminal; and extracting position information of the appropriate printing terminal from the position information of the printing terminals stored in the storing device and notifying the mobile terminal of the extracted position information.

According to the presently disclosed subject matter, a user can be guided to printing at a printing terminal appropriate for the user even if print data does not satisfy a condition for print of the printing terminal.

### BRIEF DESCRIPTION OF THE DRAWINGS

FIG. 1 is a schematic diagram illustrating a print management system 1 of a first embodiment of the presently disclosed subject matter;

FIG. 2 is a schematic diagram illustrating a mobile terminal 11;

FIG. 3 is a schematic diagram illustrating a print management server 12;

FIG. 4 is a flowchart of processing of the print management system 1;

FIG. 5 is an example of information about the mobile terminal 11, the information sent from the mobile terminal 11;

FIG. 6 is an example of user information stored in a database 13;

FIG. 7A is a schematic diagram illustrating a method for a terminal identifying unit 36 to identify a movement path of a user;

FIG. 7B is an example of data transmitted by the mobile terminal 11;

FIG. 7C is an example of user information;

FIG. 8 is an example of position information of a printing terminal stored in the database 13;

FIG. 9 is an example of printing system information stored in the database 13;

FIG. 10A is a diagram illustrating processing of a print request (step S21) in a case where a printing limit is imposed;

FIG. 10B is an example of data transmitted by the mobile terminal 11; and

FIG. 10C is an example of user information.

### DETAILED DESCRIPTION OF THE PREFERRED EMBODIMENTS

### First Embodiment

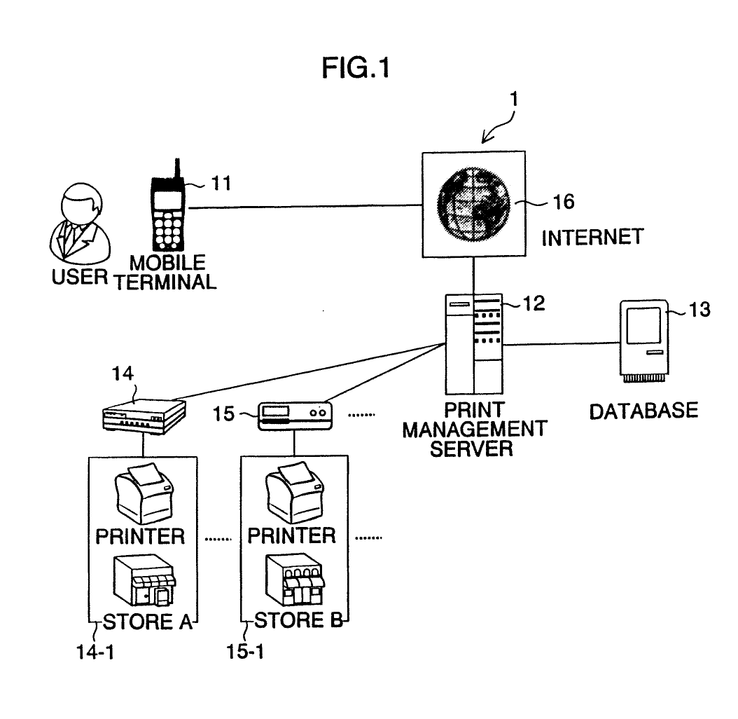

FIG. 1 is a schematic diagram of the entire structure of a print management system 1 according to the first embodiment. The print management system 1 includes a mobile terminal 11, a print management server 12, a database 13, a store A's printing system 14, a store A's printing terminal 14-1, . . . , a store B's printing system 15, a store B's printing terminal 15-1, . . . , and a network 16. Although two printing systems including the store A's printing system 14 and the store B's printing system 15 are illustrated as printing systems in FIG. 1, the number of printing systems is not limited to two. Although the store A's printing terminal 14-1 is illustrated as a store A's printing terminal and the store B's printing terminal 15-1 is illustrated as a store B's printing terminal in FIG. 1, the number of store A's printing terminals and the number of store B's printing terminals are not limited to one and may be two or more.

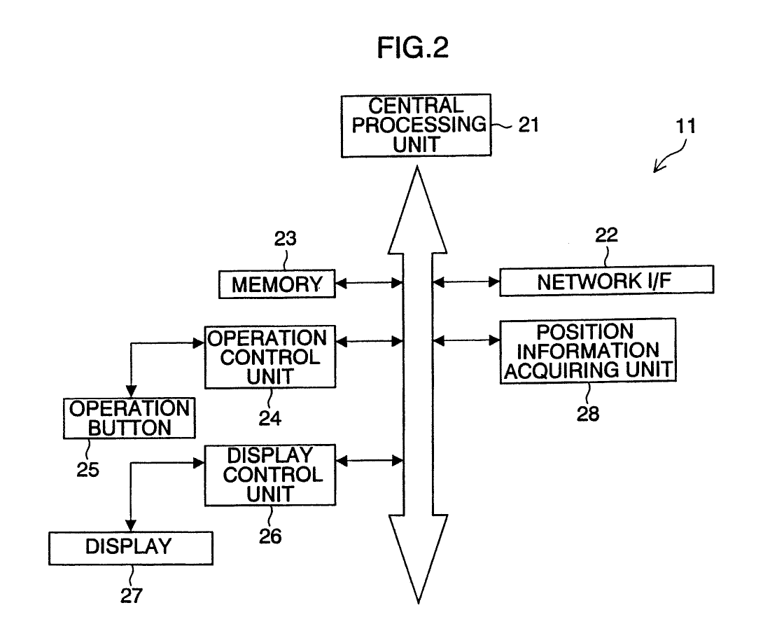

The mobile terminal 11 is connected to the print management server 12 through a network 16 such as the Internet, and includes a central processing unit 21, a network I/F (interface) 22, a memory 23, an operation control unit 24, operation buttons 25, a display control unit 26, a display 27, and a position information acquiring unit 28, as illustrated in FIG. 2.

The central processing unit 21 centrally controls the mobile terminal 11 as a whole according to a predetermined control program. The central processing unit 21 includes a memory area used as an operational working area of the central processing unit 21.

The network I/F 22 sends information about the mobile terminal 11, data for print (print data), and the like to the print management server 12. Also, the network I/F 22 receives position information of a printing terminal sent from the print management server 12 and the like.

The memory 23 stores a control program, various types of data necessary for control, and the like. Further, the memory 23 stores a terminal ID of the mobile terminal 11, a password set by a user, information about the user (a destination, a via point (stopover), a transportation mode, etc.), print data, and the like.

When there is an input through the various operation buttons 25 such as a numeric keypad, the operation control unit 24 detects it, determines which button is used as the input, and outputs the determination result to the central processing unit 21.

The display control unit 26 displays position information and the like of the printing terminals 14-1, 15-1, etc. on the display 27.

The display 27 includes, for example, a liquid crystal display capable of color display. The display 27 is used as a user interface (GUI: graphical user interface) display panel for various setting operations.

The position information acquiring unit 28 receives radio waves from a plurality of GPS (Global Positioning System) satellites to acquire position information of the mobile terminal 11 using a GPS. Although the position information acquiring unit 28 uses the GPS to acquire position information of the mobile terminal 11, a method for acquiring position information is not limited to this. For example, an area identified on the basis of a position of a base station communicated with the mobile terminal 11 may be acquired as position information.

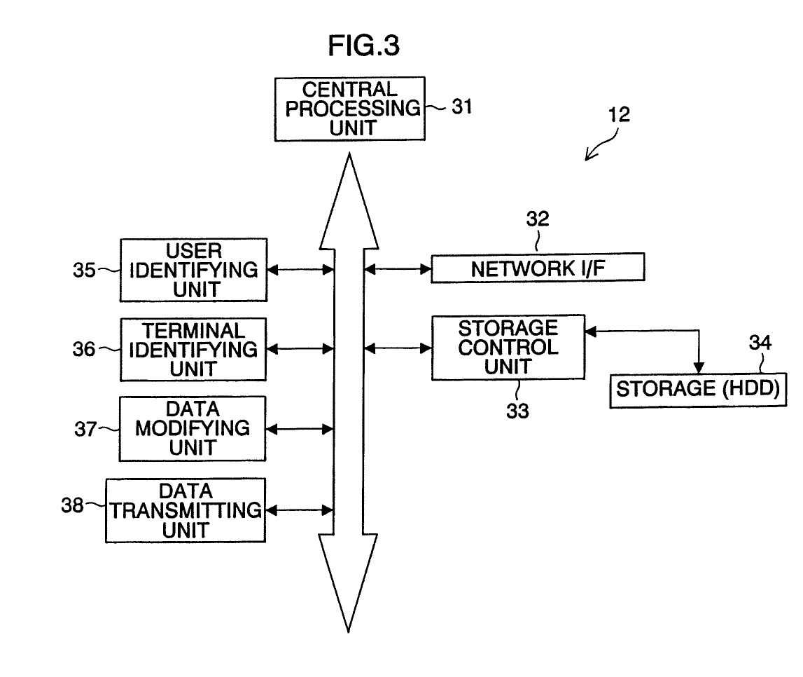

As illustrated in FIG. 3, the print management server 12 includes a central processing unit 31, a network I/F (interface) 32, a storage control unit 33, a storage 34, a user identifying unit 35, a terminal identifying unit 36, a data modifying unit 37, and a data transmitting unit 38.

The central processing unit 31 centrally controls the print management server 12 as a whole according to a predetermined control program. The central processing unit 31 has a memory area used as an operational working area of the central processing unit 31. Further, the central processing unit 31 controls input/output of data to/from the database 13.

The network I/F 32 receives information of the mobile terminal 11, print data, and the like sent from the mobile terminal 11. On the other hand, the network I/F 32 sends information of the most appropriate printing terminal and the like to the mobile terminal 11. Further, the network I/F 32 sends print data to the store A's printing system 14, the store B's printing system 15, and the like.

The storage control unit 33 controls input/output of data to/from the storage 34.

The storage 34 is, for example, a hard disk drive (HDD), and stores print data and the like inputted from the mobile terminal 11.

The user identifying unit 35 identifies a user who owns the mobile terminal 11 based on information about the mobile terminal 11 sent from the mobile terminal 11 and received by the network I/F 32 and user information stored in the database 13.

The terminal identifying unit 36 identifies a printing terminal most appropriate for the user who owns the mobile terminal 11 based on the information about the mobile terminal 11 sent from the mobile terminal 11 and received by the network I/F 32 and position information of printing terminals stored in the database 13.

The data modifying unit 37 modifies print data with reference to printing system information stored in the database 13. More specifically, the data modifying unit 37 modifies the print data to change at least one of file size, file format and paper size of the print data so that the modified print data meets a condition (requirement) of the printing terminal identified by the terminal identifying unit 36.

The data transmitting unit 38 sends the print data modified by the data modifying unit 37 to a printing system of the printing terminal identified by the terminal identifying unit 36.

The database 13 is connected to the print management server 12, and stores various types of information such as user information, position information of printing terminals, printing system information, and map information M1. The various types of information stored in the database 13 will be described in detail later.

The store A's printing system 14 is connected with all the store A's printing terminals including the store A's printing terminal 14-1, and the store B's printing system 15 is connected with all the store B's printing terminals including the store B's printing terminal 15-1. The store A's printing system 14 and store B's printing system 15 retain print data in a predetermined format, and output the print data to a store A's printing terminal and a store B's printing terminal respectively, if needed.

The store A's printing terminal 14-1 is provided in the store A, and the store B's printing terminal 15-1 is provided in the store B.

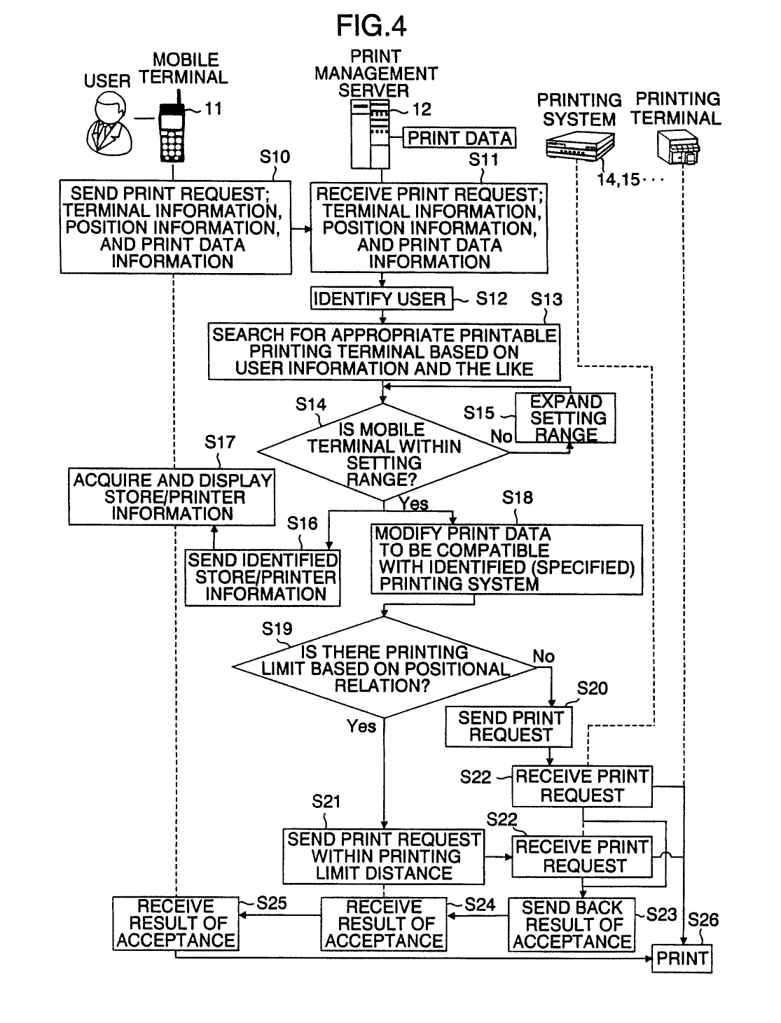

Operation of the print management system 1 configured in this way will be described. FIG. 4 is a flowchart illustrating a processing of the print management system 1.

When the operation buttons 25 of the mobile terminal 11 are operated by the user, the mobile terminal 11 sends a print request to the print management server 12 (step S10). Specifically, the operation control unit 24 accepts the operation of the operation button 25 and outputs a result of the operation to the central processing unit 21. Then, the central processing unit 21 issues a command to the position information acquiring unit 28. The position information acquiring unit 28 acquires position information of the mobile terminal 11.

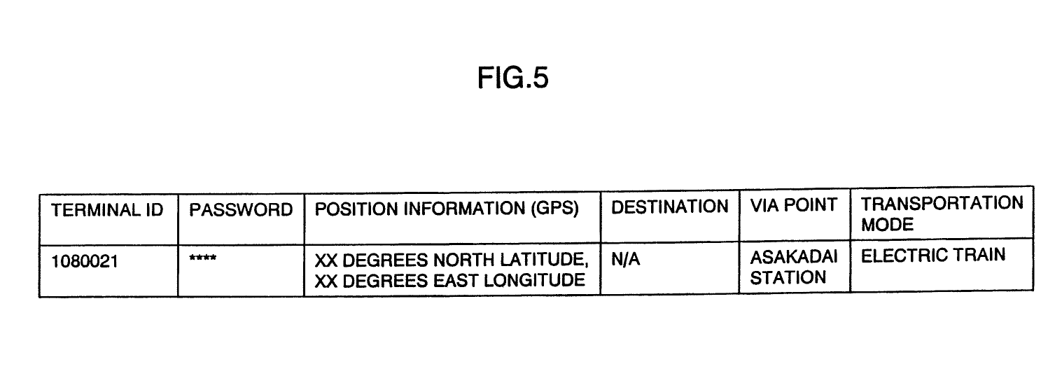

Then, the central processing unit 21 sends the position information acquired by the position information acquiring unit 28, various types of information stored in the memory 23, and print data to the print management server 12 through the network I/F 22 as a print request. The various types of information stored in the memory 23 include the information about the mobile terminal 11 (see FIG. 5) including a terminal ID of the mobile terminal 11, a password set by a user, information about the user (a destination, a via point, a transportation mode, etc.), and the like.

The network I/F 32 of the print management server 12 receives the information sent from the mobile terminal 11 in step S10 and outputs the received information to the central processing unit 31 (step S11). The central processing unit 31 gives an instruction to the user identifying unit 35. The user identifying unit 35 identifies the user who owns the mobile terminal 11 based on the information received from the mobile terminal 11 (for example, see FIG. 5) and user information stored in the database 13 (step S12).

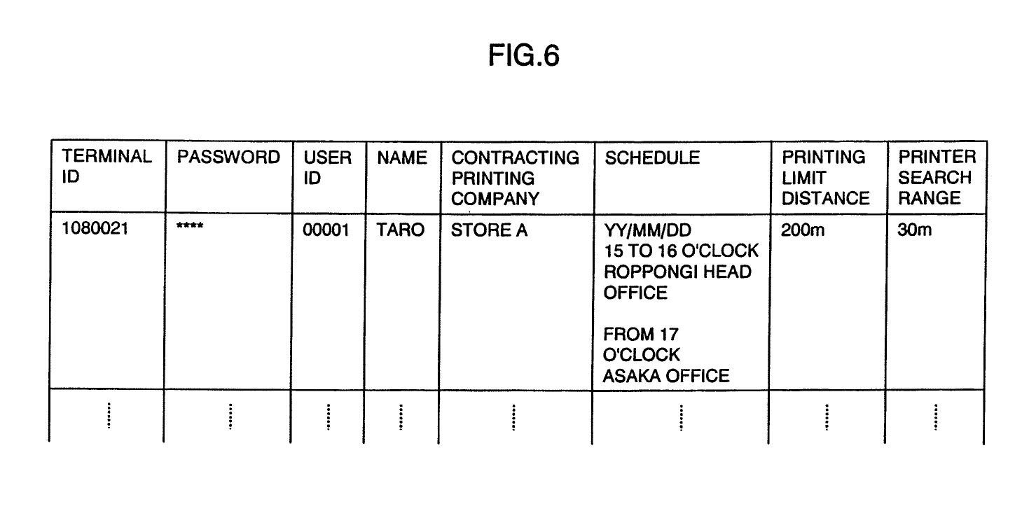

FIG. 6 illustrates an example of the user information. The user information includes a terminal ID, a password, user's information (a user ID, a name, a user's schedule, and the like), a contracting printing company, a printing limit distance, and a printer search range, which are stored and associated with each other. Because the information received from the mobile terminal 11 includes the terminal ID “1080021” (see FIG. 5), the user identifying unit 35 compares the terminal ID in the received information with a terminal ID field of FIG. 6 and identifies that the user who owns the terminal ID “1080021” is “Taro”.

The user identifying unit 35 outputs information indicating who is the user identified in step S12 to the central processing unit 31. The central processing unit 31 outputs the information indicating who is the user to the terminal identifying unit 36 as well as issuing a command to identify an appropriate printing terminal to the terminal identifying unit 36 (step S13).

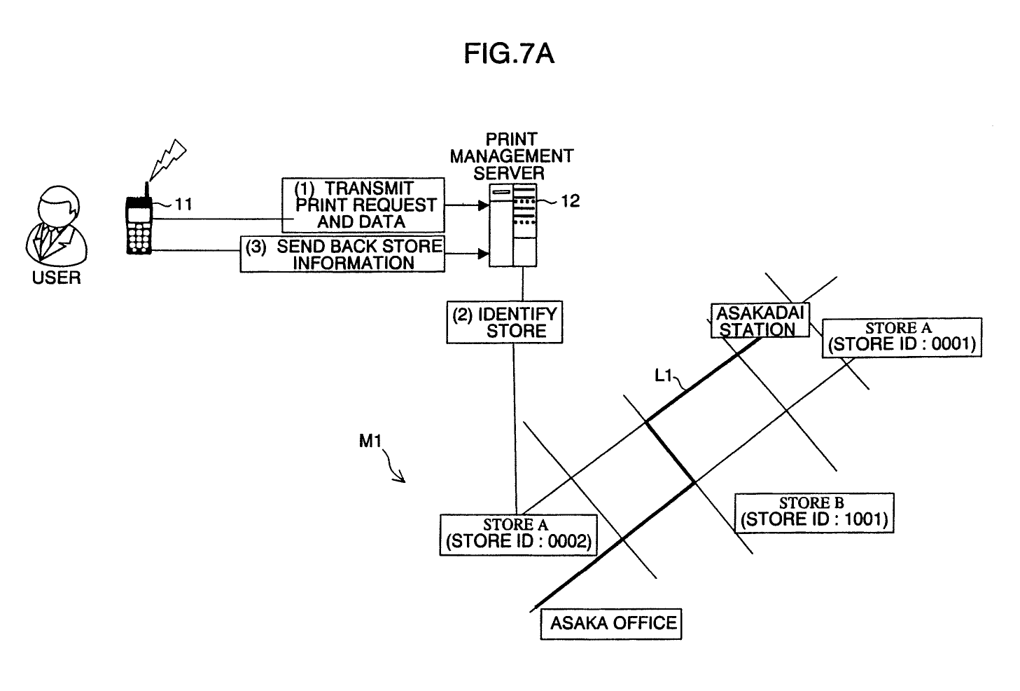

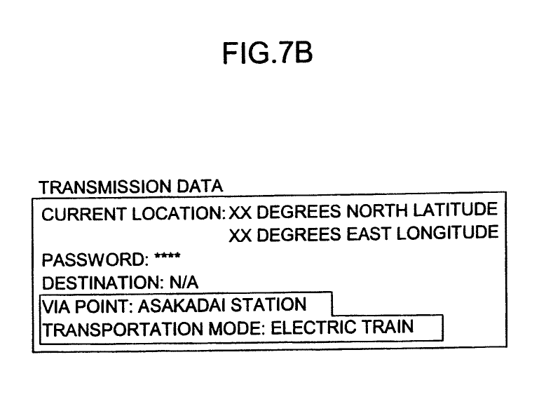

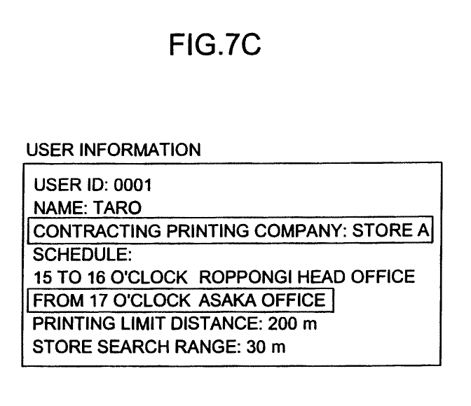

Processing of the terminal identifying unit 36 will be described specifically with reference to FIGS. 7A to 7C. The terminal identifying unit 36 identifies the movement path of the user with reference to the destination, via point, and transportation mode in the information received from the mobile terminal 11, the schedule of the user information (together with information of current time if the schedule is referenced), and the like.

The print management server 12 has received information that the via point is “Asakadai station” and the transportation mode is “electric train” from the mobile terminal 11. In the user information, information indicating “Roppongi head office from 15 to 16 o'clock, Asaka office from 17 o'clock” is stored as a schedule. Since information of the schedule is used in the present embodiment, the terminal identifying unit 36 acquires a current time from a built-in clock (not illustrated) of the print management server 12 or the like. When half-past sixteen is acquired as the current time, the terminal identifying unit 36 determines that the user are moving from the Roppongi head office to the Asaka office based on the schedule.

Then, the terminal identifying unit 36 identifies the movement path of the user (see a bold line L1 in FIG. 7A) based on map information M1 stored in the database 13 and information of the via point “Asakadai station” and the transportation mode “electric train”.

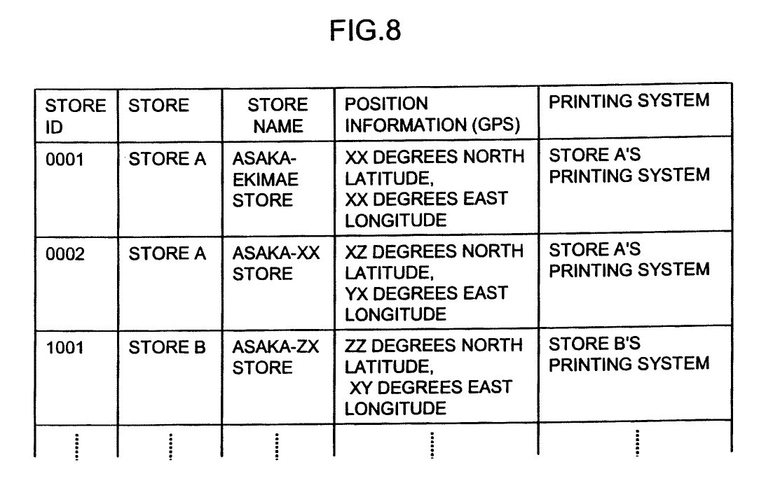

After identifying the movement path of the user, the terminal identifying unit 36 acquires store information from the database 13 to recognize a relation between the movement path and the position of a store. As illustrated in FIG. 8, the store information includes a store ID, a type of store (store A, store B, and so on), a printing system (store A's printing system 14, store B's printing system 15, and so on), a store name, and position information of a store. Then, the terminal identifying unit 36 acquires a contracting printing company and a store search range with reference to the user information (see FIG. 6), and searches for a store of the contracting printing company which exists within the store search range away from the movement path L1 of the user (distance away from the movement path L1 of the user) (step S14).

In the present embodiment, the terminal identifying unit 36 acquires information that the contracting printing company is the store A and that the store search range is “30 meters” with reference to the user information (see FIG. 6) of the user “Taro”. Then, the terminal identifying unit 36 searches for the store A, which is the contracting printing company, within 30 meters, that is, the store search range away from the movement path L1 of the user.

If there is a store of the contracting printing company within the store search range away from the movement path of the user (Yes in step S14), a printing terminal existing in the store is identified as a printing terminal appropriate for the user. In the example illustrated in FIG. 7A, the terminal identifying unit 36 identifies a printing terminal existing in Asaka XX store with store A's store ID “0002” within 30 meters away from the movement path L1 of the user, as a printing terminal appropriate for the user “Taro”. If there are a plurality of stores of the contracting printing company within the store search range away from the movement path L1 of the user, the store closest to the movement path is defined as an appropriate store.

If there is no store of the contracting printing company in the store search range away from the movement path L1 of the user (No in step S14), the terminal identifying unit 36 expands the store search range (step S15), and searches for a store of the contracting printing company again and identifies a printing terminal in a first retrieved store (for example, a store nearest to the movement path L1 of the user) as a printing terminal appropriate for the user (step S14).

The terminal identifying unit 36 outputs information of the identified printing terminal to the central processing unit 31. The central processing unit 31 sends the information of the identified printing terminal to the mobile terminal 11 through the network I/F 32 (step S16). The network I/F 22 of the mobile terminal 11 receives the information of the printing terminal outputted from the print management server 12 and outputs the received information of the printing terminal to the display control unit 26. The display control unit 26 displays the information of the printing terminal on the display 27 (step S17).

The central processing unit 31 determines whether or not the print data sent from the mobile terminal 11 (the print data is stored in the storage 34 after being received in step S11) is compatible with the printing system of the printing terminal identified in step S14, with reference to the printing system information stored in the database 13. For example, the central processing unit 31 determines whether or not the sent print data meets or satisfies the condition of the identified printing terminal.

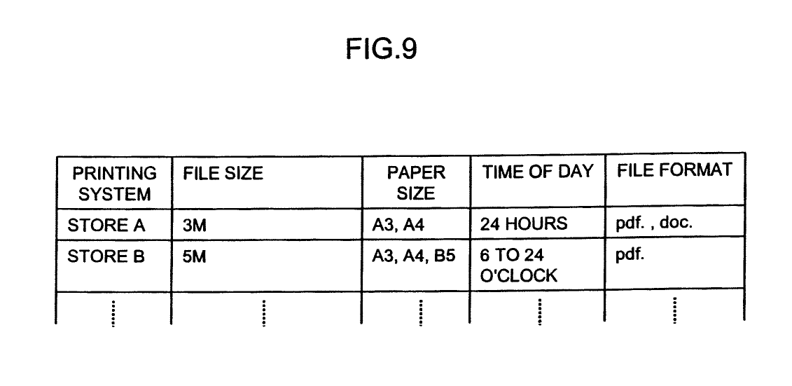

FIG. 9 is an example of the printing system information. The printing system information includes conditions of a printable file such as a maximum file size per file, a printable paper size, a printable time of day, and a printable file format, which are stored and associated with a printing system. The central processing unit 31 determines whether or not a condition of the print data file satisfies a condition of a file of the store A's printing system 14. In the present embodiment, since the printing system of the identified printing terminal is the store A's printing system 14, the central processing unit 31 determines whether or not the file size is less than or equal to 3 MB (megabyte), whether or not the specification of paper size is A3 (420 mm×297 mm) or A4 (297 mm×210 mm), and whether or not the file format is pdf (Portable Document Format) or doc (Microsoft Word document format).

If the print data is compatible with the printing system of the printing terminal identified in steps S13 to S15, the central processing unit 31 does nothing. However, if the print data is not compatible with the printing system of the printing terminal identified in steps S13 to S15, the central processing unit 31 issues a command to the data modifying unit 37. The data modifying unit 37 modifies the print data to be compatible with the printing system (step S18).

The central processing unit 31 acquires a printing limit distance with reference to the user information (see FIG. 6) and determines whether or not a printing limit is imposed (step S19). In the present embodiment, since the printing limit distance in the user information of the user “Taro” is “200 meters”, the central processing unit 31 determines that a printing limit of 200 meters is imposed.

If no printing limit is imposed (No in step S19), the central processing unit 31 promptly sends the print data or the print data modified in step S18 and the information of the user who has requested printing to the printing system of the printing terminal identified in steps S13 to S15, thereby making a print request (step S20).

If a printing limit is imposed (Yes in step S19), the central processing unit 31 measures a distance between the position information of the mobile terminal 11 received in step S11 and the printing terminal identified in step S14. And then, if the distance is less than or equal to the printing limit distance, sends the print data or the print data modified in step S18 and the information of the user who has requested printing to the printing system of the printing terminal identified in steps S13 to S15, thereby making a print request (step S21).

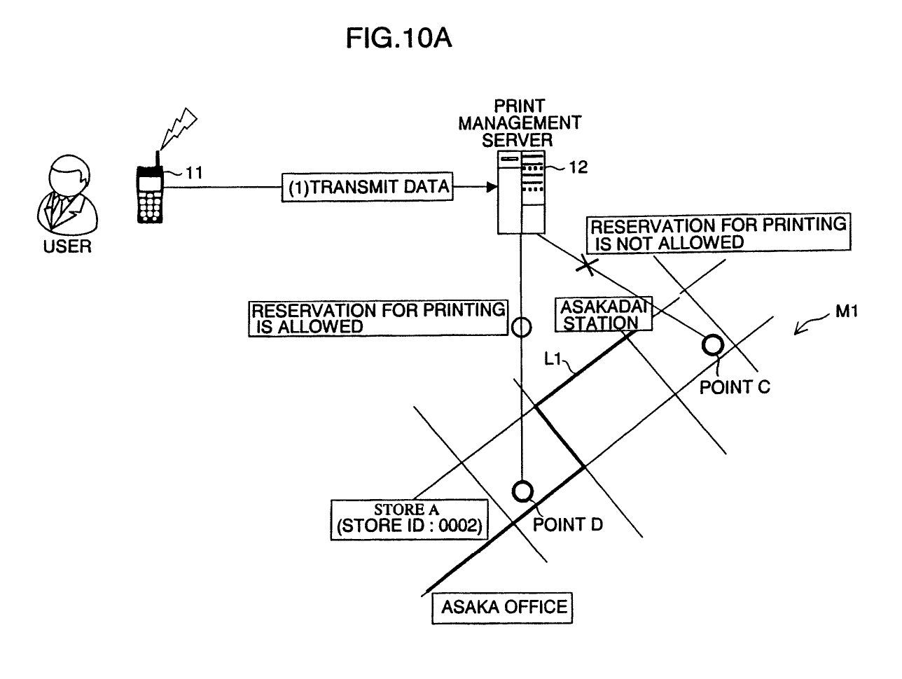

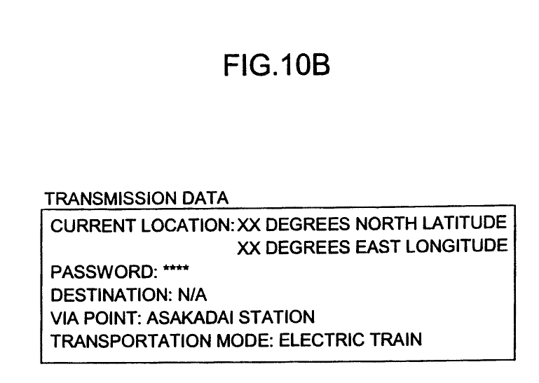

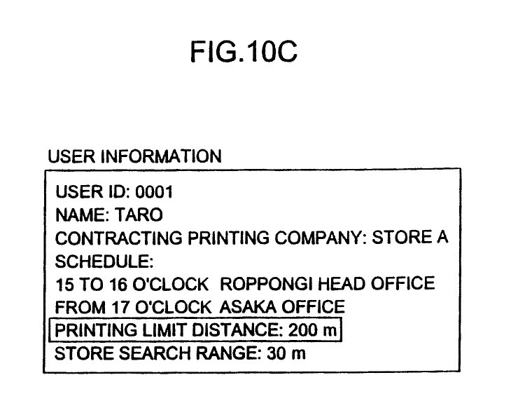

The processing of step S21 will be described using FIGS. 10A to 10C. In the present embodiment, the printing terminal existing in the store A with the store ID “0002” has been identified as the printing terminal appropriate for the user in steps S13 to S15. When the position information received in step S11 is point C, a distance between the point C and the store A with the store ID “0002” is more than 200 meters, which is the printing limit distance, and therefore the central processing unit 31 does not send the print data and the like. If the position information received in step S11 becomes point D, that is, if the distance between the current position of the user and the store A whose store ID is “0002” becomes the printing limit distance of 200 meters, the central processing unit 31 sends the print data and the like.

Since the print data is modified so as to be compatible with the printing system in step S18 if the print data is not compatible with the printing system, the print management server 12 can make a print request using an API (Application Program Interface) of the printing system in steps S20 and S21.

When the print data and the like are sent from the print management server 12 to the store A's printing system 14 in step S20 or S21, the store A's printing system 14 receives the print data and the like (step S22). Then, the store A's printing system 14 sends a reception result and information indicating that the printing has been accepted to the print management server 12 (step S23).

The print management server 12 sends the information indicating that the printing has been accepted by the printing system to the mobile terminal 11 (step S24), and the mobile terminal 11 receives this information (step S25). Thereby, the user can know that the print request has been accepted.

Then, when the user operates the printing terminal identified in steps S13 to S15 and thereby inputs a password or the like, the printing terminal checks if the user operating the printing terminal is identical to the user who made the print request by comparing the password or the like with the user's information received in step S22.

And, if they are confirmed to be identical, the printing terminal acquires the print data from the printing system and performs print using the print data (step S26).

According to the present embodiment, a movement path of a user can be identified, and a printing terminal existing in a location near the movement path can be determined to be an appropriate terminal.

Further, according to the present embodiment, printing is allowed at a printing terminal appropriate for a user even if print data does not satisfy a condition for print of the printing terminal (in a case where a file format of the data for print (the print data) is unsupported by the store or the printer or in a case where print data does not satisfy the condition of a file printable by a printing terminal, and the like).

Further, according to the present embodiment, print data is sent to an appropriate printing terminal if it is determined that the mobile terminal has entered within a predetermined distance from the appropriate printing terminal. Therefore, printed material may unlikely be seen by other people, print data may unlikely be printed by other people. Therefore, a secure printing method can be provided.

In a currently prevailing print management system, printing is managed by using an eight-digit number. A user of the currently prevailing print management system receives the eight-digit number from the print management system after requesting for printing and then enters the eight-digit number at a store to perform printing. However, in this case, printing may be performed even when another person enters an eight-digit number in a random manner.

In contrast, according to the present embodiment, printing is limited depending on a distance between a user and a printing terminal to reduce a time between reservation for printing and printing. Therefore, print data may unlikely be printed by other people, and security can be improved.

In the present embodiment, the print management server 12 is connected to the store A's printing system 14 and the store B's printing system 15, and the store A's printing system 14 and the store B's printing system 15 centrally control a plurality of store A's printing terminals and a plurality of store B's printing terminals respectively. However, the presently disclosed subject matter is not limited by the above embodiment. The print management server 12 may function also as a printing system. The print management server 12 may be directly connected to each printing terminal.

Although a movement path is identified based on a schedule and a current time in step S13 in the present embodiment, a schedule is not necessary required. For example, if a destination is known, a path can be identified based on position information received in step S11 and the destination. If a destination and a via point are known, a path can be identified based on position information received in step S11, the via point, and the destination.

In the present embodiment, print data is modified so as to be compatible with a printing system with reference to printing system information stored in the database 13 in step S18 if the print data is not compatible with the printing system. In spite of the present embodiment, information equivalent to printing system information may be prerecorded in user information instead of the printing system information so that print data can be modified based on the equivalent information.

Although in the present embodiment, print data is sent to an appropriate printing terminal if it is determined that a mobile terminal has entered within a predetermined distance from the appropriate printing terminal in order to reduce risk that printed material may be seen by other people, print data may be printed by other people, and the like, the method for reducing such risk is not limited to this. For example, unless the mobile terminal has entered within a predetermined distance from the appropriate printing terminal, download from the printing system to the printing terminal may be prohibited, or printing at the printing terminal may be prohibited.

Although print data sent from the mobile terminal 11 is printed in the present embodiment, print data recorded in the database 13 or the storage 34 in advance may be printed, for example, by being previously transmitted from another terminal.

The presently disclosed subject matter can be provided not only as the print management system including devices such as the mobile terminal 11 and the print management server 12, but also provided as a stand-alone device such as the print management server 12. Further, the presently disclosed subject matter is not limited to a device or a system, and can be provided as a program applied to a device or a system, a computer-readable recording medium including a computer-readable program code for causing a computer to execute the above described process or a computer program product.

What is claimed is:

1. A print management apparatus comprising:
a storing device for storing position information of a plurality of printing terminals placed in different locations, information indicating a condition of a file printable by each printing terminal, and print data;
a receiving device for receiving position information of a mobile terminal owned by a user;
a terminal identifying device for identifying an appropriate printing terminal from among the plurality of printing terminals based on the received position information of the mobile terminal and the position information of the plurality of printing terminals stored in the storing device;
a data modifying device for modifying a file format of the print data so that the print data satisfies the condition of the file stored in the storing device;
a sending device for sending the print data modified by the data modifying device to the appropriate printing terminal; and
a notifying device for extracting position information of the appropriate printing terminal based on the position information of the printing terminals stored in the storing device and for notifying the mobile terminal of the extracted position information.

2. The print management apparatus according to claim 1,
wherein the storing device stores at least one of a file size, a paper size, and a file format as the information indicating the condition of the file printable by the printing terminal.

3. A print management apparatus comprising:
a storing device for storing position information of a plurality of printing terminals placed in different locations, and print data;
a receiving device for receiving position information of a mobile terminal owned by a user;
a terminal identifying device for identifying an appropriate printing terminal from among the plurality of printing terminals based on the received position information of the mobile terminal and the position information of the plurality of printing terminals stored in the storing device;
a sending device for sending the print data stored in the storing device to the appropriate printing terminal;
a determining device for determining whether or not the mobile terminal is within a predetermined range from the appropriate printing terminal based on the position information of the mobile terminal and the position information of the printing terminals;
a controlling device for performing control so as to allow printing at the appropriate printing terminal only if the determining device determines that the mobile terminal is within the predetermined range from the appropriate printing terminal; and
a notifying device for extracting position information of the appropriate printing terminal based on the position information of the printing terminals stored in the storing device and notifying the mobile terminal of the extracted position information.

4. The print management apparatus according to claim 3,
wherein the controlling device controls the sending device to send the print data to the appropriate printing terminal if the determining device determines that the mobile terminal is within a predetermined distance from the appropriate printing terminal.

5. The print management apparatus according to claim 1,
wherein the receiving device receives information indicating a movement path of the user who owns the mobile terminal, and
the terminal identifying device identifies the movement path of the user based on the received information about the movement path, and identifies a printing terminal existing within a predetermined range away from the identified movement path of the user, as the appropriate printing terminal.

6. The print management apparatus according to claim 3,
wherein the receiving device receives information indicating a movement path of the user who owns the mobile terminal, and
the terminal identifying device identifies the movement path of the user based on the received information about the movement path, and identifies a printing terminal existing within a predetermined range away from the identified movement path of the user, as the appropriate printing terminal.

7. The print management apparatus according to claim 5,
wherein the receiving device acquires a destination of the user, and
the terminal identifying device identifies the movement path of the user based on the received destination and the position information of the mobile terminals.

8. The print management apparatus according to claim 6,
wherein the receiving device acquires a destination of the user, and
the terminal identifying device identifies the movement path of the user based on the received destination and the position information of the mobile terminals.

9. The print management apparatus according to claim 1, further comprising a current time acquiring device for acquiring a current time,
wherein the storing device stores a schedule of the user, and
the terminal identifying device identifies the movement path of the user based on the schedule of the user and the acquired current time, and identifies a printing terminal existing within a predetermined range away from the identified movement path of the user, as the appropriate printing terminal.

10. The print management apparatus according to claim 3, further comprising a current time acquiring device for acquiring a current time,
wherein the storing device stores a schedule of the user, and
the terminal identifying device identifies the movement path of the user based on the schedule of the user and the acquired current time, and identifies a printing terminal existing within a predetermined range away from the identified movement path of the user, as the appropriate printing terminal.

11. A print management method comprising the steps of:
receiving position information of a mobile terminal owned by a user, by a print management apparatus;
identifying an appropriate printing terminal from among a plurality of printing terminals based on the received position information of the mobile terminal and position information of the plurality of printing terminals stored in a storing device of the print management apparatus;
modifying a file format of print data stored in the storing device so that the print data satisfies a condition of a file printable by the printing terminal stored in the storing device;
sending the modified print data to the appropriate printing terminal; and
extracting position information of the appropriate printing terminal from the position information of the printing terminals and notifying the mobile terminal of the extracted position information.

12. A print management method comprising the steps of:
receiving position information of a mobile terminal owned by a user, by a print management apparatus;
identifying an appropriate printing terminal from among a plurality of printing terminals based on the received position information of the mobile terminal and position information of the plurality of printing terminals stored in a storing device of the print management apparatus;
sending print data stored in the storing device to the appropriate printing terminal;
determining whether or not the mobile terminal is within a predetermined range from the appropriate printing terminal based on the position information of the mobile terminal and the position information of the printing terminals;
performing control so as to allow printing at the appropriate printing terminal only if the determining step determines that the mobile terminal is within the predetermined range from the appropriate printing terminal; and
extracting position information of the appropriate printing terminal from the position information of the printing terminals stored in the storing device and notifying the mobile terminal of the extracted position information.

13. A computer-readable recording medium including instructions stored thereon, such that when the instructions are read and executed by a processor, the processor is configured to perform the steps of:
receiving position information of a mobile terminal owned by a user;
identifying an appropriate printing terminal from among a plurality of printing terminals based on the received position information of the mobile terminal and stored position information of the plurality of printing terminals stored in a storing device;
modifying a file format of print data stored in the storing device so that the print data satisfies a condition of a file printable by the printing terminal stored in the storing device;
sending the modified print data to the appropriate printing terminal; and
extracting position information of the appropriate printing terminal from the position information of the printing terminals and notifying the mobile terminal of the extracted position information.

14. A computer-readable recording medium including instructions stored thereon, such that when the instructions are read and executed by a processor, the processor is configured to perform the steps of:
receiving position information of a mobile terminal owned by a user;
identifying an appropriate printing terminal from among a plurality of printing terminals based on the received position information of the mobile terminal and position information of the plurality of printing terminals stored in a storing device;
sending print data stored in the storing device to the appropriate printing terminal;
determining whether or not the mobile terminal is within a predetermined range from the appropriate printing terminal based on the position information of the mobile terminal and the position information of the printing terminals;
performing control so as to allow printing at the appropriate printing terminal only if the determining step determines that the mobile terminal is within the predetermined range from the appropriate printing terminal; and
extracting position information of the appropriate printing terminal from the position information of the printing terminals stored in the storing device and notifying the mobile terminal of the extracted position information.
